(19) United States
(12) Patent Application Publication
(10) Pub. No.: US 2009/0147294 A1
(43) Pub. Date: Jun. 11, 2009

(54) METHODS AND SYSTEMS FOR ASSESSING RESOURCE UTILIZATION IN A PRINT PRODUCTION ENVIRONMENT

(75) Inventors: John C. Handley, Fairport, NY (US); Sudhendu Rai, Fairport, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 11/951,860

(22) Filed: Dec. 6, 2007

(51) Int. Cl. G06F 15/00

(52) U.S. Cl. 358/1.15

(57) ABSTRACT

A method of assessing resource utilization in a print production environment may include receiving a plurality of utilization profiles where each utilization profile corresponds to a utilization of a resource in an enterprise. For at least one resource in the enterprise, a computing device may determine a distance between a utilization profile for the resource and a utilization profile for one or more other resources in the enterprise. The computing device may convert one or more distances into at least one visualization, and a report management system may generate a report comprising the visualization.

### BACKGROUND

It is common for a resource in a print environment to be under-utilized or over-utilized with respect to other resources in the print environment. For example, one printer may process certain jobs that are only received a few times a week, while another printer may process jobs that are received hourly.

Over-utilization of multiple resources can signal the need to add resources to a print environment, while under-utilization of resources may signal the need to consolidate resources. For example, if the majority of printers in a print environment are continuously busy, this may indicate a high job demand, which may signal a print shop operator of the need to add resources. Similarly, if certain printers are continuously busy while others are continuously idle, this may signal the need for a print shop operator to consolidate resources in order to maximize the print shop's efficiency.

As such, print shop operators would like to analyze resource utilization in order to evaluate whether resources in a print environment can be consolidated or whether additional resources are needed.

### SUMMARY

Before the present methods are described it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “resource” is a reference to one or more resources and equivalents thereof known to those skilled in the art, and so forth. Unless defined otherwise, all technical and scientific terms used herein have the same meanings as commonly understood by one of ordinary skill in the art. As used herein the term “comprising” means “including, but not limited to.”

In an embodiment, a method of assessing resource utilization in a print production environment may include receiving a plurality of utilization profiles where each utilization profile corresponds to a utilization of a resource in an enterprise. For at least one resource in the enterprise, a computing device may determine a distance between a utilization profile for the resource and a utilization profile for one or more other resources in the enterprise. The computing device may convert one or more distances into at least one visualization, and a report management system may generate a report comprising the visualization.

In an embodiment, a system for assessing resource utilization in a print production environment may include a plurality of resources in an enterprise, a processor and a processor-readable storage medium in communication with the processor. The processor-readable storage medium may include one or more programming instructions for performing a method of assessing resource utilization in a print production environment. The method may include receiving a plurality of utilization profiles, where each utilization profile corresponds to a utilization of a resource in an enterprise, for at least one resource in the enterprise, determining a distance between a utilization profile for the resource and a utilization profile for one or more other resources in the enterprise, converting one or more distances into at least one visualization and generating a report comprising the visualization.

### BRIEF DESCRIPTION OF THE DRAWINGS

FIG. 1 depicts an exemplary flow chart depicting a method of assessing resource utilization according to an embodiment.

FIG. 2 depicts an exemplary utilization profile for a resource over a period of one day according to an embodiment.

FIG. 3 illustrates exemplary utilization profiles for two similar resources according to an embodiment.

FIG. 4 depicts exemplary utilization profiles according to an embodiment.

FIG. 5 illustrates exemplary utilization profiles for two complementary resources according to an embodiment.

FIG. 6 depicts an exemplary visualization according to an embodiment.

FIG. 7 depicts an exemplary visualization according to an embodiment.

FIG. 8 depicts an exemplary dendrogram of clusters formed using hierarchical agglomerative clustering according to an embodiment.

FIG. 9 illustrates an exemplary visualization using K-means clustering according to an embodiment.

FIG. 10 illustrates an environment suitable for practicing the illustrative embodiments according to an embodiment.

### DETAILED DESCRIPTION

The following terms shall have, for the purposes of this application, the meanings set forth below.

A “job” is a logical unit of work that is to be completed for a client. In a document production environment, a job may include one or more print jobs from one or more clients. A production system may include multiple devices configured to process a plurality of jobs. Although the disclosed embodiments pertain to document production systems, the disclosed methods and systems can be applied to production systems in general.

A “print job” is a job processed in a document production environment. For example, a print job may include a unit of work that results in the production of credit card statements corresponding to a certain credit card company, bank statements corresponding to a certain bank, a document or the like. Although the disclosed embodiments pertain to print jobs, the disclosed methods and systems can be applied to jobs in other production environments, such as automotive manufacturing, semiconductor production and the like.

A “resource” is a device that performs a processing function on a job. For example, in a print production environment, a resource may include a printer, a copier, a binder, a hole-punch, a collator, a sealer or any other equipment used to process print jobs.

A “utilization profile” is a representation of a resource's activity over a period of time. For example, a utilization profile may be represented as a binary time series where a value of ‘1’ indicates that a resource is busy, and a value of ‘0’ indicates that a resource is idle.

A “log” is a file used to store one or more performance measurements for one or more resources. For example, in a print production environment, a printer log may include print job start times, print job end times, print job processing times or the like.

An “enterprise” is a production environment that includes multiple items of equipment to manufacture and/or process jobs that may be customized based on customer requirements. For example, in a print production environment, an enterprise may include a plurality of print shops.

“Similar resources” are resources that are busy and idle at substantially the same times. For example, if Resource 1 and Resource 2 are busy for the duration of hour one, and Resource 1 and Resource 2 are idle during the remaining time periods, then Resource 1 and Resource 2 may be considered similar resources.

A “similarity measure” is a measurement of the similarity between two utilization profiles. A similarity measure may be determined using a Jaccard distance, a correlation distance, a Euclidean distance, a hamming distance or the like.

“Complementary resources” are resources that are busy at substantially different times. For example, if Resource 1 is busy during hour one, while Resource 2 is busy during hour two, and both Resource 1 and Resource 2 are idle during the remaining time periods, then Resource 1 and Resource 2 may be considered complementary resources.

A “dissimilarity measure” is a measurement of the dissimilarity between two utilization profiles. A dissimilarity measure may be determined using a complementary utilization profile distance, a correlation distance, optimal alignment or the like.

A “visualization” is a visual representation of one or more relationships between data. A visualization may include a graph, a chart, a dendrogram, a diagram, a figure or other similar visual representation.

“Multidimensional scaling” is a statistical analysis used in data visualization to determine similarities or dissimilarities in data. Multidimensional scaling may map a distance, such as the distance between two utilization profiles, into a two-dimensional representation, such as coordinates in a plane.

“Clustering” is the partitioning of a set into subsets, or clusters, such that each member of the cluster shares one or more common traits. For example, resources in an enterprise may be grouped into clusters based on the distances between their corresponding utilization profiles.

A “report” is information pertaining to resource utilization and may include one or more visualizations or the like. The report may be used to assess resource utilization.

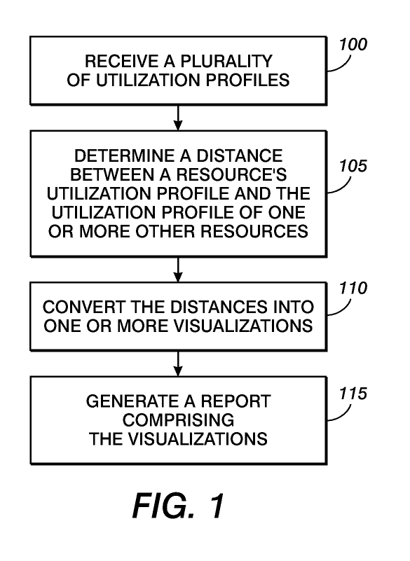

FIG. 1 illustrates an exemplary flow chart for assessing resource utilization according to an embodiment. Utilization profiles that correspond to one or more resources in a print environment may be received 100. A utilization profile is a representation of a resource's activity over a period of time and may include a timeline that indicates when a resource is busy or idle. For example, a utilization profile may be represented as a binary time series where a value of ‘1’ indicates that a resource is busy, and a value of ‘0’ indicates that a resource is idle.

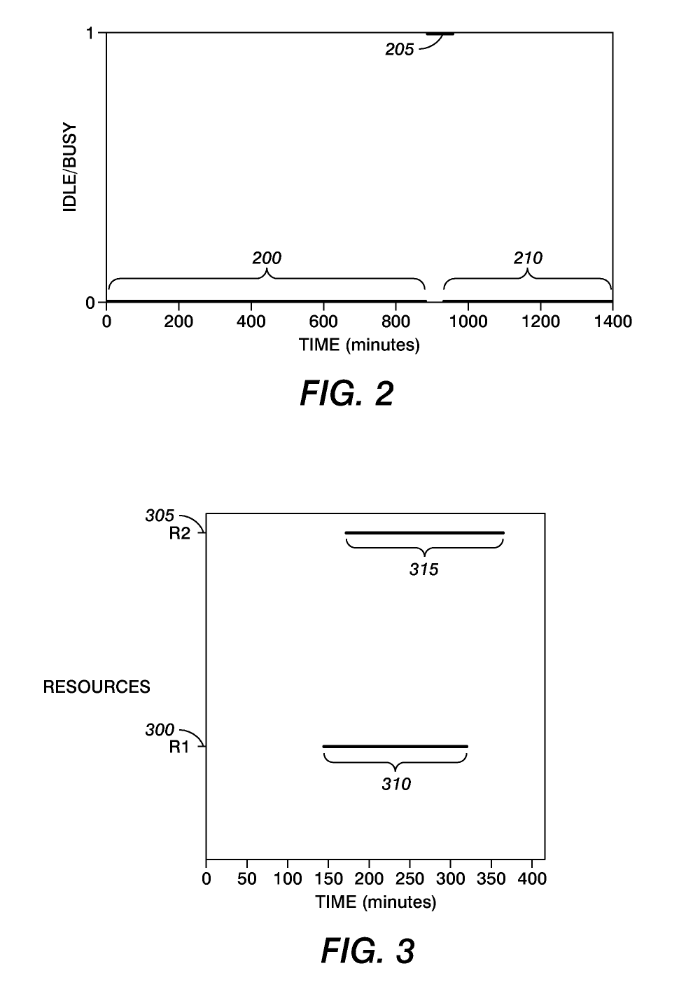

FIG. 2 depicts an exemplary utilization profile for a resource over a period of one day. As illustrated by FIG. 2, the resource is idle during the interval from 0 minutes to approximately 950 minutes 200. busy during the interval from approximately 950 minutes to approximately 970 minutes 205 and idle during the interval from approximately 970 minutes to approximately 1450 minutes 210.

In an embodiment, a utilization profile may be received 100 directly from a resource, from resource logs associated with a resource or the like. For example, a utilization profile of a printer in a print environment may be received 100 directly from the printer or may be received 100 from a log associated with the printer. A log is a file used to store one or more performance measurements for one or more resources.

For at least one resource in an enterprise, a distance between the utilization profile of the resource and one or more other resources in the enterprise may be determined 105. The distances may be used to determine, for example, whether a plurality of resources are similar. Similar resources are resources that are busy and idle at substantially the same times. FIG. 3 illustrates exemplary utilization profiles for two similar resources, R1 300 and R2 305. As illustrated by FIG. 3, R1 300 is busy between the interval from 150 minutes to 320 minutes 310 and idle at every other time. R1 305 is busy between the interval from 160 minutes to 350 minutes 315 and idle at every other time. As such, R1 300 and R2 305 may be considered similar resources.

In an embodiment, the similarity between the utilization profiles of similar resources may be determined using measures such as a Jaccard distance, a correlation measure of similarity, a Euclidean distance, a Hamming distance or the like. A similarity measure is a measure of the similarity between two utilization profiles.

A Jaccard distance between the utilization profiles of two resources, R1 and R2, may be determined by the following:

$$1 - \frac{\vert R 1 ⋂ R 2 \vert}{\vert R 1 ⋃ R 2 \vert} .$$

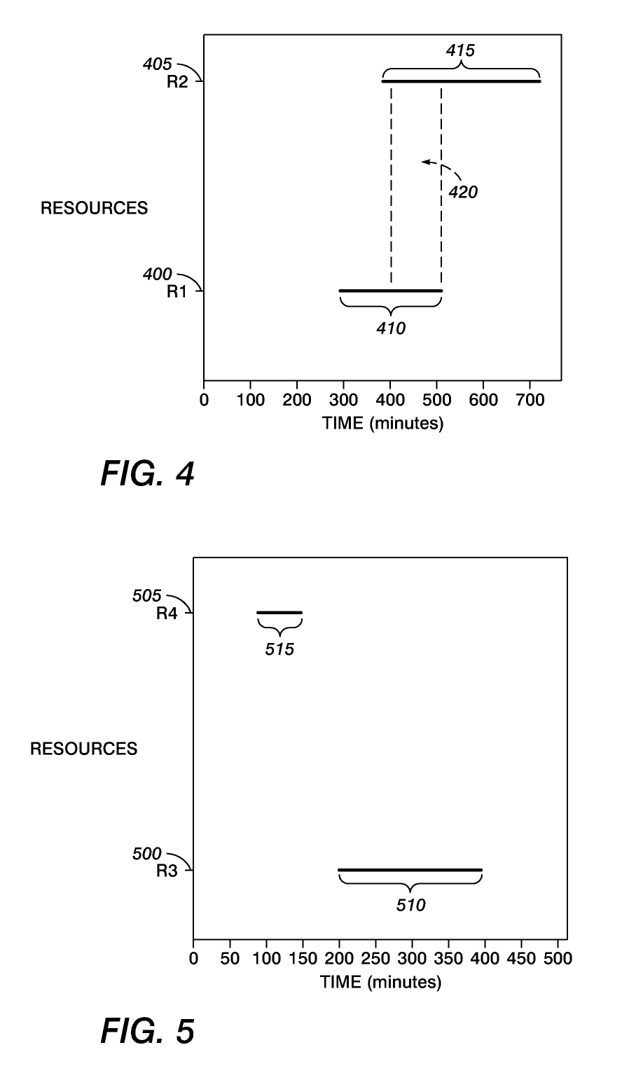

In an embodiment, two utilization profiles that are substantially similar may have a Jaccard distance of approximately zero. For example, FIG. 4 depicts utilization profiles for two resources, R1 400 and R2 405. R1 400 may be busy for a total of 200 minutes per day 410, while R2 405 may be busy for 300 minutes a day 415. As illustrated by FIG. 4, R1 400 and R2 405 are simultaneously busy for a total of 100 minutes a day 420 (i.e., the interval from 400 minutes and 500 minutes). As such the Jaccard distance between the utilization profiles of R1 400 and R2 405 (i.e., 0.75) may be determined by dividing the number of time units that both resources are simultaneously busy (i.e. 100) by the number of time units that both resources are independently busy (i.e., 400) and subtracting that quantity from ‘1.’

In an embodiment, a correlation measure of similarity between utilization profiles may be determined by the following:

$$d ( X , Y ) = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2} {\sum }_{i = 1}^{n} {( {Y}_{i} - \overline{Y} )}^{2}}} ,$$

where X, and Y, are utilization profile data entries at time i for utilization profiles X and Y, respectively, and X̅ and Y̅ are the averages of the data values in utilization profiles X and Y, respectively. In such an embodiment, 1−d(X, Y) may represent a similarity between utilization profiles X and Y.

In an embodiment, a Euclidean distance between utilization profiles may be determined by the following:

$$d ( X , Y ) = \sqrt{{\sum }_{i = 1}^{n} {( {X}_{i} - {Y}_{i} )}^{2} ,}$$

where X, and Y, are utilization profile data entries at time i for utilization profiles X and Y, respectively.

In an embodiment, the Hamming distance between resource utilization profiles may measure the minimum number of substitutions required to change one utilization profile into the other. For example, the utilization profile for one resource may be represented by ‘0101101,’ where ‘0’ represents that the resource is idle and ‘1’ represents that the resource is busy. The utilization profile for a second resource may be represented by ‘0110001.’ The Hamming distance between these two utilization profiles is ‘3’ because three digits must be changed for the two utilization profiles to have the same value.

Distances between utilization profiles may be used to determine whether two resources are complementary. Complementary resources are resources that are busy and idle at substantially different times, FIG. 5 illustrates exemplary utilization profiles for two complementary resources, R3 500 and R4 505. As illustrated by FIG. 5, R3 500 is busy between the interval from 200 minutes to 400 minutes 510, while R4 505 is busy between the interval from 100 minutes to 150 minutes 515 and idle between the interval from 200 minutes to 400 minutes. As such, R3 500 and R4 505 are complementary resources.

In an embodiment, a dissimilarity measure may be determined by subtracting a similarity value from a constant. For example, if a similarity measure, as determined by one of the measures described above is ‘0.235’ and a pre-determined constant is ‘1,’ then the dissimilarity between the two utilization profiles may be represented ‘0.765’ (i.e., 1-0.235).

In an embodiment, a correlation between utilization profiles may be determined by the following:

$$d ( X , Y ) = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2} {\sum }_{i = 1}^{n} {( {Y}_{i} - \overline{Y} )}^{2}}}$$

where X, and Y, are utilization profile data entries at time i for utilization profiles X and Y, respectively, and X̅ and Y̅ are the averages of the data values in utilization profiles X and Y, respectively. In such an embodiment, 1−d(X, Y) may represent a dissimilarity between utilization profiles X and Y.

In an embodiment, two utilization profiles may be optimally aligned. Optimal alignment measures the extent to which two utilization profiles are able to interleave, such that the busy time of one utilization profile corresponds to the idle time of another utilization profile. For example, if X and Y represent two utilization profiles, the minimum overlap between X and Y may be determined as the minimum overlap in busy times when the time associated with one utilization profile is shifted. In other words, a dissimilarity measure between X and Y may be determined by the following:

$${d}_{opt} = {min}_{x} {\sum }_{i} X ( t ) Y ( t + s ) , where s is the time shift .$$

Referring back to FIG. 1, distances between utilization profiles may be converted 110 into one or more visualizations. A visualization is a visual representation of relationships between data. A visualization may include a graph, a chart, a dendrogram, a diagram, a figure or other similar visual representation.

In an embodiment, distances may be converted into a visualization using multidimensional scaling. Multidimensional scaling is a statistical analysis used in data visualization to determine similarities or dissimilarities in data. As such, multidimensional scaling may be used to determine whether resource utilization profiles are similar or complementary to each other. In an embodiment, multidimensional scaling may be used to map a distance, such as the distance between two utilization profiles, into a two-dimensional representation, such as coordinates in a plane. For example, given a distance d_{Ij}: 1≦i≦N, multidimensional scaling may be used to determine coordinates in the plane {(x₁, y₁) . . . (X_{N}, y_{N})} such that the Euclidean distances are as close as possible to the distances between utilization profiles. The squared difference between the utilization profile distance and the corresponding Euclidean distance is the stress of mapping, and may be represented by.

$${\sum }_{1 \leq i \leq j \leq N} {[ {d}_{ij} - \sqrt{{( {x}_{i} - {x}_{j} )}^{2} + {( {y}_{i} - {y}_{j} )}^{2}} ]}^{2} .$$

The lower the stress value, the more reliable the visualization. Table 1 illustrates an exemplary matrix of distances between resource utilization profiles according to an embodiment. For example, the distance between the utilization profile of Resource 3, R3, and Resource 5, R5, is 0.46.

TABLE 1

| | R1 | R2 | R3 | R4 | R5 |
|---|---|---|---|---|---|
| R1 | 0.00 | 1.81 | 0.42 | 0.42 | 0.50 |
| R2 | 1.81 | 0.00 | 1.43 | 1.43 | 1.26 |
| R3 | 0.42 | 1.43 | 0.00 | 0.00 | 0.46 |
| R4 | 0.42 | 1.43 | 0.00 | 0.00 | 0.46 |
| R5 | 0.50 | 1.26 | 0.46 | 0.46 | 0.00 |

Table 2 illustrates exemplary results of using multidimensional scaling to determine Euclidean distances between the utilization profiles depicted in Table 1 according to an embodiment. As illustrated, applying multidimensional scaling to the distances in Table 1 yields coordinates for the resources as well as Euclidean distance between the utilization profiles of the resources.

TABLE 2

| | (0.63, 0.10) | (−1.18, 0.00) | (0.24, −0.18) | (0.24, −0.18) | (0.07, 0.26) |
|---|---|---|---|---|---|
| (0.63, 0.10) | 0.00 | 1.81 | 0.47 | 0.47 | 0.58 |
| (−1.18, 0.00) | 1.81 | 0.00 | 1.43 | 1.43 | 1.28 |
| (0.24, −0.18) | 0.47 | 1.43 | 0.00 | 0.00 | 0.46 |
| (0.24, −0.18) | 0.47 | 1.43 | 0.00 | 0.00 | 0.46 |
| (0.07, 0.26) | 0.58 | 1.28 | 0.46 | 0.46 | 0.00 |

In another example, Table 3 illustrates distances between resource utilization profiles determined using a Hamming distance.

TABLE 3

| | R1 | R2 | R3 | R4 | R5 | R6 | R7 | R8 | R9 |
|---|---|---|---|---|---|---|---|---|---|
| R1 | 0 | 98 | 59 | 12 | 98 | 115 | 15 | 195 | 11 |
| R2 | 98 | 0 | 139 | 92 | 38 | 179 | 95 | 135 | 91 |
| R3 | 59 | 139 | 0 | 47 | 139 | 126 | 56 | 236 | 52 |
| R4 | 12 | 92 | 47 | 0 | 92 | 103 | 9 | 189 | 5 |
| R5 | 98 | 38 | 139 | 92 | 0 | 195 | 95 | 97 | 91 |
| R6 | 115 | 179 | 126 | 103 | 195 | 0 | 112 | 230 | 108 |
| R7 | 15 | 95 | 56 | 9 | 95 | 112 | 0 | 192 | 8 |
| R8 | 195 | 135 | 236 | 189 | 97 | 230 | 192 | 0 | 188 |
| R9 | 11 | 91 | 52 | 5 | 91 | 108 | 8 | 188 | 0 |

As a Hamming distance may measure the dissimilarity between utilization profiles, the smaller the distance between two utilization profiles, the more similar the two utilization profiles. For example, the distance between the utilization profiles of R4 and R7 is 9. The maximum distance in this example is 1440 because there are 1440 minutes in a day. As such, these two utilization profiles are relatively similar (i.e., R4 and R7 are busy and idle at substantially the same times). In contrast, the distance between the utilization profiles of R5 and R6 is 195, which indicates that these two utilization profiles are complementary (i.e., that R5 and R6 are busy and idle at substantially different times).

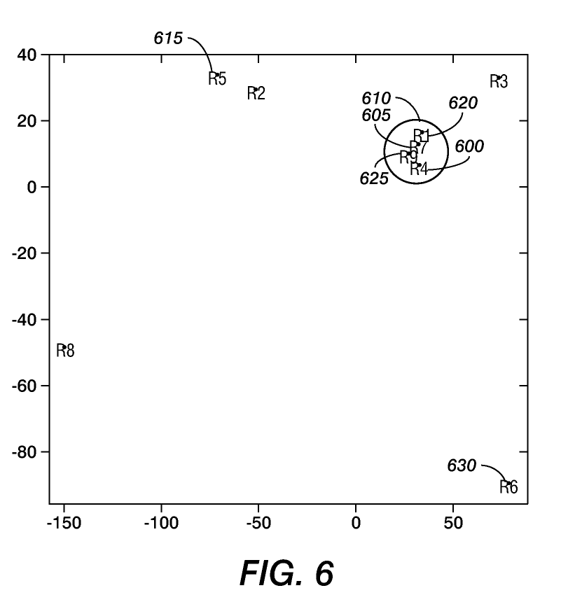

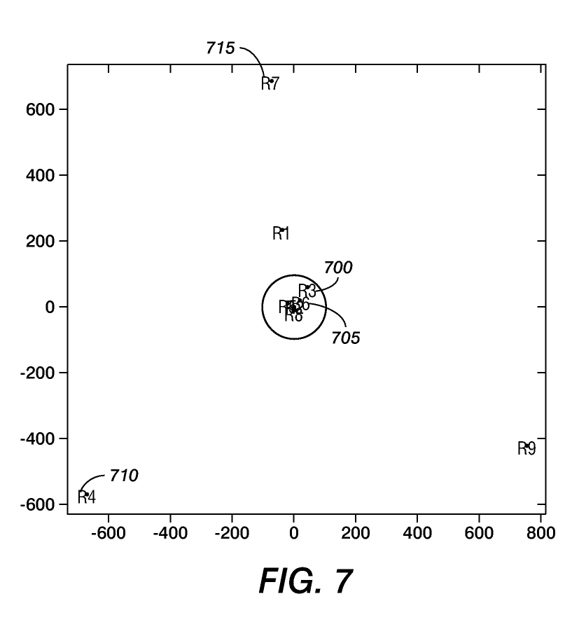

FIG. 6 illustrates an exemplary visualization of the distances depicted in Table 3 projected into two dimensions using multidimensional scaling. FIG. 6 clearly depicts similar and complementary resources. For example, as discussed above, R4 600 and R7 605 are similar resources, and, as such, are located relatively close to each other on FIG. 6. Similarly, R5 615 and R6 630 are complementary resources and, as such, are located relatively far apart on FIG. 6.

Table 4 illustrates distances between resource utilization profiles determined using complementary Hamming similarities (i.e., ‘1440’—‘Hamming distance from Table 3’). For example, the Hamming distance between the utilization profiles of R4 and R7 in Table 3 is 9, so the complementary Hamming similarity between R14 and R7 in Table 4 is 1431.

TABLE 4

| | R1 | R2 | R3 | R4 | R5 | R6 | R7 | R8 | R9 |
|---|---|---|---|---|---|---|---|---|---|
| R1 | 0 | 1342 | 1381 | 1428 | 1342 | 1325 | 1425 | 1245 | 1429 |
| R2 | 1342 | 0 | 1301 | 1348 | 1402 | 1261 | 1345 | 1305 | 3349 |
| R3 | 1381 | 1301 | 0 | 1393 | 1301 | 1314 | 1384 | 1204 | 1388 |
| R4 | 1428 | 1348 | 1393 | 0 | 1348 | 1337 | 1431 | 1251 | 1435 |
| R5 | 1342 | 1402 | 1301 | 1348 | 0 | 1245 | 1345 | 1343 | 1349 |
| R6 | 1325 | 1261 | 1314 | 1337 | 1245 | 0 | 1328 | 1210 | 1332 |
| R7 | 1425 | 1345 | 1384 | 1431 | 1345 | 1328 | 0 | 1248 | 1432 |
| R8 | 1245 | 1305 | 1204 | 1251 | 1343 | 1210 | 1248 | 0 | 1252 |
| R9 | 1429 | 1349 | 1388 | 1435 | 1332 | 1332 | 1432 | 1252 | 0 |

FIG. 7 illustrates an exemplary visualization of the distances depicted in Table 4 projected into two dimensions using multidimensional scaling. As illustrated by FIG. 7, complementary resources are located relatively together. For example, R3 700 and R6 705 have very little overlap in their utilization, so these two resources are complementary and may be examined for consolidations. In contrast, R4 710 and R7 715 are located relatively far apart from one another, and as such are similar resources.

In an embodiment, distances may be converted into a visualization using clustering. Clustering is the partitioning of a set into subsets, or clusters, such that each member of the cluster shares one or more common traits. For example, resources in an enterprise may be grouped into clusters based on the distances between their corresponding utilization profiles. In an embodiment, each cluster may include one or more resources. Referring back to FIG. 6, the circle 610 encompassing R1 620, R4 600, R7 605 and R9 625 indicates a cluster comprising these resources. This cluster indicates that R1 620, R4 600, R7 605 and R9 625 are busy at similar times and may represent a potential opportunity for consolidation. In an embodiment, resources may be clustered using one or more clustering techniques such as hierarchical agglomerative clustering, K-means clustering or the like.

Hierarchical agglomerative clustering may be performed by regarding each resource as a separate cluster, then merging these atomic clusters into larger clusters until one or more predefined termination conditions are satisfied. At each step, the two most similar resources (clusters or single resource) may be identified and merged into a larger cluster. Deciding which two clusters are closest may be performed using a measure of the distance between each remaining pair of clusters. Such a proximity measure is called a linkage metric. Exemplary inter-cluster linkage metrics include single link, complete link and average link.

A single link metric may measure the similarity of two clusters based on the distance between their closest (i.e., most similar) points. The single link metric may often generate long straggle clusters. d(C₁, C₂)=min {d(x,y)|xεC₁, yεC₂}.

A complete link metric may measure the similarity of two clusters based on the similarity of their most distant (i.e., least similar) points. The complete link metric may tend to form compact clusters. d(C₁, C₂) max {d(x,y)|xεC₁, yεC₂}.

An average link metric may measure the similarity of two clusters based on the average similarity of the points contained in the clusters. d(C₁, C₂)=average {d(x,y)|xεC₁, yεC₂}.

The particular link metric used to measure similarity may have an effect on the clustering of the resources because different link metrics reflect different measures of closeness and connectivity. In an embodiment, values for a plurality of link metrics may be determined. Resources may be considered close to other resources, for example, if the distance between the resources is less than the distance between the resource and any other resource. Relative “closeness” may depend on the nature of the data. Other methods of determining closeness may also be performed within the scope of the present disclosure.

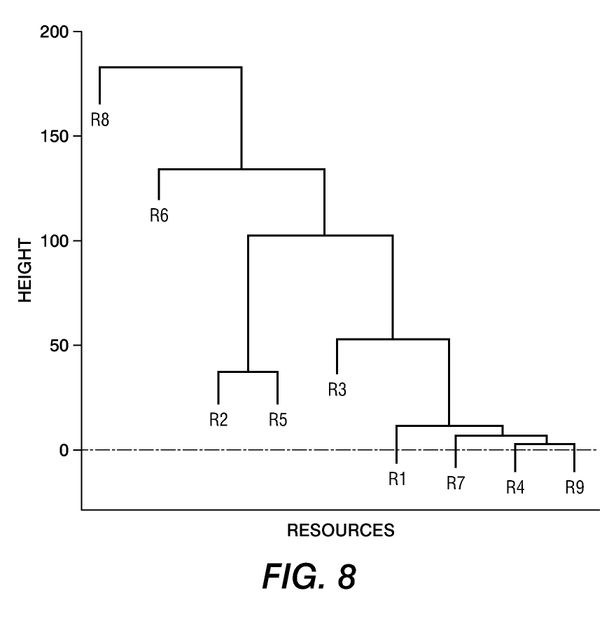

FIG. 8 depicts an exemplary dendrogram of clusters formed using hierarchical agglomerative clustering. As illustrated in FIG. 8, nine resources were clustered based on the distance between the utilization profiles for each resource and/or cluster of resources. Clusters may be determined by selecting a distance threshold between clusters. Clusters that exceed this threshold may be determined to be distinct. For example, a distance threshold of 50 may result in a determination of 3 clusters: {R2, R5}, {R3} and {R1, R4, R7, R9}. Different distance thresholds may result in a different number of clusters.

In an embodiment, an optimal threshold may be determined by selecting the threshold that optimizes a measure of cluster separation and compactness. The optimal threshold may result in clusters that are tightly arranged about a center and distant from every other cluster.

In an embodiment, K-means clustering may be performed by first determining a value. K, equal to the number of clusters to find. Next, a set of initial cluster centers, x₁, . . . , x_{K}, may be chosen. These may be chosen at random or by using a heuristic. For each point or vendor x in the dataset, the distances from that point to each of the centers may be computed: d₁=d(x, x₁), i=1, . . . , K. Resource x may be assigned to the cluster with the closest center. After all points or resources have been assigned, each center may be re-determined by computing the medoid for each cluster. A medoid is a representative object of a data set determined by finding the center of a cluster and selecting the object that is closest to the center. After selecting the medoid, the distances between the medoid and the other points may be re-determined. For example, if the members of cluster i are determined to be {xᵢ₁, . . . , xᵢₙ} the new center or medoid is the point in the set which minimizes

$${\sum }_{j = 1}^{n} d ( y , {x}_{ij} ) .$$

The new centers for each cluster are used to assign all the points or resources to the cluster with the closest center. The process is repeated until the cluster centers do not change after each iteration.

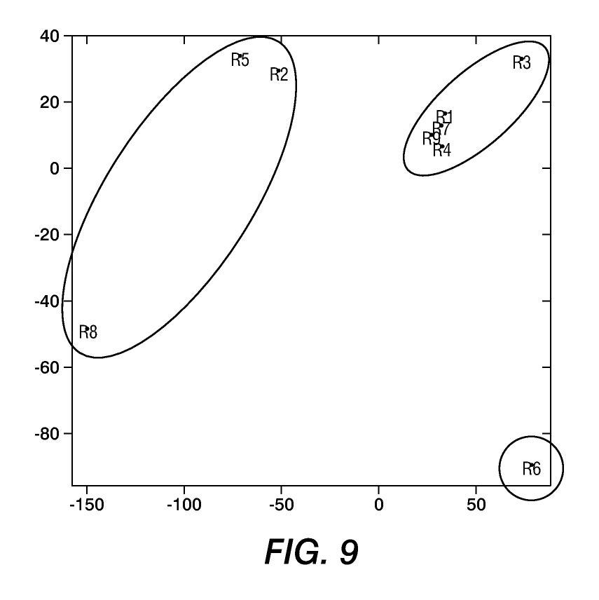

FIG. 9 illustrates an exemplary visualization of the distances depicted in Table 3 using K-means clustering. As illustrated by FIG. 9, there are three distinct clusters, {R1, R3, R4, R7, R9}, {R2, R5, R8}, and {R6}. Each cluster represents a plurality of similar resources. For example, the cluster {R1, R3, R4, R7, R9} illustrates that R1, R3, R4, R7 and R9 are similar resources that may be considered for job rescheduling.

Referring back to FIG. 1, a report may be generated 115 for one or more users. A report is an analysis of resource utilization and may include one or more visualizations or the like. In an embodiment, the visualization included in the report may include a graph, a dendrogram, a chart and figure or the like that represents distances between a plurality of utilization profiles. The visualization may also depict a plurality of similar resources and/or a plurality of complementary resources.

In an embodiment, the report may be distributed to one or more users via a report management system. The report may be distributed to users by printing, emailing, faxing, scanning or the like. In an embodiment, the report may be distributed to a remote user by a communications network or the like. In an embodiment, a user may use the report to determine whether resources may be consolidated and/or whether additional resources may be added to an enterprise.

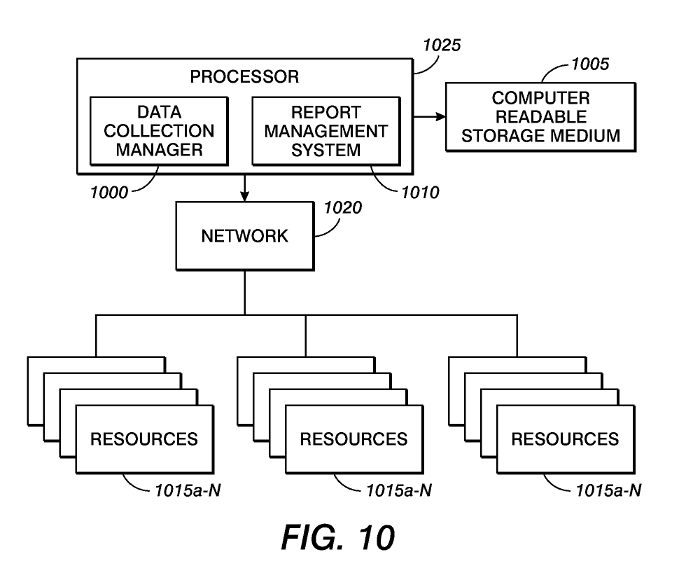

FIG. 10 depicts an environment suitable for practicing the illustrative embodiments. A processor 1025 may include a data collection manager 1000 and/or a report management system 1010. The processor 1025 may be in communication with a computer-readable storage medium 1005 and one or more resources 1015a-N via a network 1020. The processor 1025 may be implemented on a stand-alone computer system or may integrated into the resources 1015a-N. The processor 1025 may also be implemented by distributed components such as separate electronic devices. A network 1020 may interconnect the resources 1015a-N with the processor 1025, as illustrated in FIG. 10. The network 1020 may include a local area network (LAN) or a wide area network (WAN), such as the Internet, the World Wide Web or the like. The network 1020 may also be formed by communication links that interconnect the processor 1025 and the resources 1015a-N. Alternatively, the disclosed embodiments may be practiced in environments where there is no network connection.

It will be appreciated that various of the above-disclosed and other features and functions, or alternatives thereof may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of assessing resource utilization in a print production environments the method comprising:
receiving a plurality of utilization profiles, wherein each utilization profile corresponds to a utilization of a resource in an enterprise;
for at least one resource in the enterprise, determining, by a computing device, a distance between a utilization profile for the resource and a utilization profile for one or more other resources in the enterprise;
converting, by the computing device, one or more distances into at least one visualization; and
generating, by a report management system, a report comprising the visualization.

2. The method of claim 1, wherein receiving a plurality of utilization profiles comprises:
receiving, by a data collection manager, the plurality of utilization profiles from one or more resources.

3. The method of claim 1, wherein receiving a plurality of utilization profiles comprises:
receiving, by a data collection manager, the plurality of utilization profiles from one or more logs associated with one or more resources.

4. The method of claim 1, wherein determining a distance between the utilization profile for the resource and for one or more other resource in the enterprise comprises determining one or more of the following similarity measures:
a Jaccard distance;
a correlation measure of similarity;
a Euclidean distance; and
a Hamming distance.

5. The method of claim 1, wherein determining a distance between the utilization profile for the resource and for one or more other resource in the enterprise comprises determining one or more of the following dissimilarity measures:
a difference between a constant and a similarity measure;
a correlation distance; and
an optimal alignment distance.

6. The method of claim 1, wherein converting one or more distances comprises:
applying multidimensional scaling to the distances to generate the visualization, wherein multidimensional scaling comprises mapping the distances into a two-dimensional representation.

7. The method of claim 1, wherein converting one or more distances comprises:
grouping the resources into one or more clusters based on the corresponding distance.

8. The method of claim 7, wherein grouping the resources into one or more clusters comprises:
performing hierarchical agglomerative clustering using a link metric, wherein the link metric comprises one or more of a single link metric, a complete link metric and an average link metric.

9. The method of claim 7, wherein the grouping the resources into one or more clusters comprises performing K-means clustering.

10. The method of claim 1, wherein generating a report comprises:
displaying a visualization representing the one or more distances, wherein the visualization depicts at least one of one or more similar resources and one or more complementary resources, wherein the visualization comprises one or more of a graph, a dendrogram, a chart, a diagram and a figure.

11. The method of claim 1, wherein generating a report comprises one or more of printing, faxing, emailing and scanning the report to one or more users.

12. The method of claim 1, wherein generating a report comprises distributing the report to one or more remote users by a communications network.

13. A system for assessing resource utilization in a print production environment, the system comprising:
a plurality of resources in an enterprise;
a processor; and
a processor-readable storage medium in communication with the processor, wherein the processor-readable storage medium contains one or more programming instructions for performing a method of assessing resource utilization in a print production environment, the method comprising:
receiving a plurality of utilization profiles, wherein each utilization profile corresponds to a utilization of a resource in an enterprise,
for at least one resource in the enterprise, determining a distance between a utilization profile for the resource and a utilization profile for one or more other resources in the enterprise,
converting one or more distances into at least one visualization, and
generating a report comprising the visualization.

14. The system of claim 13, wherein the one or more programming instructions for receiving a plurality of utilization profiles comprises one or more programming instructions for:
receiving the plurality of utilization profiles from one or more resources.

15. The system of claim 13, wherein the one or more programming instructions for receiving a plurality of utilization profiles comprises one or more programming instructions for:
receiving the plurality of utilization profiles from one or more logs associated with one or more resources.

16. The system of claim 13, wherein the one or more programming instructions for determining a distance between the utilization profile for the resource and for one or more other resource in the enterprise comprises one or more programming instructions for determining one or more of the following similarity measures:
a Jaccard distance;
a correlation measure of similarity;
a Euclidean distance; and
a Hamming distance.

17. The system of claim 13, wherein the one or more programming instructions for determining a distance between the utilization profile for the resource and for one or more other resource in the enterprise comprises one or more programming instructions for determining one or more of the following dissimilarity measure:
a difference between a constant and a similarity measure;
a correlation distance; and
an optimal alignment distance.

18. The system of claim 13, wherein the one or more programming instructions for converting one or more distances comprises one or more programming instructions for:
applying multidimensional scaling to the distances to generate the visualization, wherein multidimensional scaling comprises mapping the distances into a two-dimensional representation.

19. The system of claim 13, wherein the one or more programming instructions for converting one or more distances comprises one or more programming instructions for:
grouping the resources into one or more clusters based on the corresponding distance.

20. The system of claim 19, wherein the one or more programming instructions for grouping the resources into one or more clusters comprises one or more programming instructions for:
performing hierarchical agglomerative clustering using a link metric, wherein the link metric comprises one or more of a single link metric, a complete link metric and an average link metric.

21. The system of claim 19, wherein the one or more programming instructions for grouping the resources into one or more clusters comprises one or more programming instructions for performing K-means clustering.

22. The system of claim 13, wherein the one or more programming instructions for generating a report comprises one or more programming instructions for:
displaying the visualization representing the one or more distances, wherein the visualization depicts at least one of one or more similar resources and one or more complementary resources, wherein the visualization comprises one or more of a graph, a dendrogram, a chart, a diagram and a figure.
